(19) United States
(12) Patent Application Publication
(10) Pub. No.: US 2006/0277185 A1
(43) Pub. Date: Dec. 7, 2006

(54) Access control server, a user terminal, and an information access control, method

(76) Inventors: Akiko Sato, Musashino (JP); Yusuke Mishina, Kunitachi (JP); Masahiro Motobayashi, Tokyo (JP)

Correspondence Address: REED SMITH LLP;Suite 1400, 3110 Fairview Park Drive, Falls Church, VA, 22042, US

(21) Appl. No.: 11/447,085

(22) Filed: Jun. 6, 2006

(30) Foreign Application Priority Data
Jun. 6, 2005 (JP) 2005-165400

(51) Int. Cl. G06F 17/30

(52) U.S. Cl. 707/9

(57) ABSTRACT

A system for unified management of personal information under control of the user while protecting the privacy of that information. A user terminal owned by the user, and an access control server connected to an external service terminal for providing a service to the user terminal, includes an access control module for controlling access from external service terminals to personal information retained in the user terminal; and the access control module accepts attribute information for the external service terminal and the access control policy for setting the access rights to the personal information held in the user terminal, and decides whether to not to grant access rights based on the accepted external service terminal attribute information and the accepted access control policy, and sends the decision results to the user terminal.

### CLAIM OF PRIORITY

The present invention claims priority from Japanese applications JP 2005-165400 filed on Jun. 6, 2005, the content of which is hereby incorporated by reference into this application.

### FIELD OF THE INVENTION

The present invention relates to a computer system for externally accessing information possessed by a user, and relates in particular to an access control method for protecting personal information stored in the user terminal.

### BACKGROUND OF THE INVENTION

Systems that provide different types of services over a network sometimes need personal user information in order to provide the service requested by the user. Most systems that offer services therefore store personal information required for business uses in their own database. Personal information is usually managed in locations dispersed over the network.

The type of personal information managed by these systems offering user services may span diverse areas. A company making sales over the Internet for example handles information such as the buyer's purchase history and customer recommendations in addition to information needed for sending the product, such as the user's name, address and telephone number. This type of information is displayed to the logged-in user and utilized to stimulate the customer's desire to make future purchases.

Among this personal information, the name and address are disclosed to the shipping or deliver company when writing the shipping box labels. However personal information such as the user's purchase history and information on personal preferences must be handled carefully and should not be disclosed to anyone except the user. In the systems of the related art, the system providers set and controlled access to the personal information.

FIG. 10 is a block diagram of the personal information access system of the related art.

A user terminal 201, an external service terminal 121 and an access control server 131 are connected via a network 142.

The access control server 131 includes an access control module 132 and a database. An access control policy data 113 and a personal information 114 are stored in this database. The user terminal 201 stores the access control policy data. The external service terminal 121 stores a external service terminal-profile data 123.

The access control server 131 receives an access request for personal information from the external service terminal (212). The access control server 131 then decides based on the access control policy data 113 whether or not that particular external service terminal 121 possesses access rights. The access control server 131 then discloses accessible information to the external service terminal 121 based on the decision results (213).

The user determines the contents of the access control policy data 113 and may then record those contents via the user terminal 101 into the access control server 131 (211).

A formula allowing the user to record access control policy data via the terminal is disclosed in JP-A No. 2002-14862.

JP-A No. 2004-260716 discloses method for installing all the functions of the access control server in a device possessed by the user and preventing the leakage (outflow) of personal information and the access control policy.

### SUMMARY OF THE INVENTION

The user providing the information is essentially responsible for the privacy of that personal information. The user should therefore also possess the right to control the personal information. Namely the user should possess access control right to that personal information.

However in conventional technology, personal information of this type is stored in databases on a network. Moreover when the database is managed by multiple servers then the personal information is dispersed over the network. In a state where accessible over a network, this structure does not allow the user himself to control access to the personal information.

In the current state of affairs, a database administrator controls access to the data within the database. In other words, the service provider who manages the system controls access to the personal information.

In most cases, the service provider managing the system controls access rights to the personal information stored in the database, and sometimes discloses information contrary to the wishes of the user. Also, detailed conditions that the user wants complied with regarding disclosure are not observed in controlling access to personal information.

There is also the problem that protecting the personal information stored in the database places a large burden on the service provider serving as the system administrator in terms of system operation and responsibility to maintain confidentiality.

To resolve these problems, the JP-A No. 2002-14862 proposes registering the user's access control policy in the access control server in advance to comply with the user's needs. However, in this case the users must register their own access control policy in all databases. Also when the user wanted to make changes in that access control policy, then changing all the registered access control data was necessary which placed a large burden on the user. Further, delays occurred when updating data, creating the problem that the user's needs could not be complied with in real-time.

The above problems were caused by the fact that the personal information that the user should control is stored while dispersed throughout the network. These problems can be resolved if the users manage their own personal information, and control the policy that allows access to personal information.

JP-A No. 2004-260716 attempts to resolve the above problems by proposing a system to load all data such as personal information and a control means, access control policy and access control processing within an IC card possessed by the user. The user would then constantly carry a device such as a cellular telephone or a portable information terminal capable of connecting to a network. However at present, loading all of these functions into that type of device is impossible due to limits on performance.

This invention includes a user terminal possessed by the user and an access control server connected to an external service terminal for providing services to that user terminal; and an access control module to control access from the external service terminal to the personal information retained in the user terminal; and characterized in that the access control module accepts attribute information for the external service terminal and the access control policy for setting access rights to the personal information held in the user terminal, and decides whether to grant access rights based on received external service terminal attribute information and access control policy, and then sends those decision results to the user terminal.

This invention therefore allows users to manage their own personal information in a unified manner in order to protect the confidentiality of the information.

### BRIEF DESCRIPTION OF THE DRAWINGS

FIG. 1 is a block diagram showing the structure of the computer system of the embodiment of this invention;

FIG. 2 is a sequence chart showing the information access control processing of the embodiment of this invention;

FIG. 3 is a flowchart of the processing by the user terminal in the embodiment of this invention;

FIG. 4 is a flowchart of the processing by the external service terminal in the embodiment of this invention;

FIG. 5 is a flowchart of the processing by the access control server in the embodiment of this invention;

FIG. 6 is an explanatory drawing showing an example of the access control policy data in the embodiment of this invention;

FIG. 7 is an explanatory drawing showing an example of the external service terminal profile data of the embodiment of this invention;

FIG. 8 is an explanatory drawing showing the encoded access control policy data of the embodiment of this invention;

FIG. 9 is an explanatory drawing showing the encoded external service terminal profile data i of the embodiment of this invention; and

FIG. 10 is a block diagram of the personal information access system of the related art.

### DETAILED DESCRIPTION OF THE PREFERRED EMBODIMENTS

A summary of the concept of the embodiment of this invention is described first.

In the embodiment of this invention, a user terminal 101 carried by the user manages the personal information and access control policy.

An external service terminal 121 requests the necessary personal information to supply a service to the user terminal 101. The external service terminal 121 also provides its own external service terminal profile data to the access control server 131.

The access control server 131 contains an access control processing function, and obtains the access control policy data from the user terminal, and the external service terminal profile data from the external service terminal.

The user terminal 101, the external service terminal 121 and the access control server 131 contain encrypting (or encoding) units to ensure security by mutually concealing the data, the completeness of the data, and mutual authentication, etc.

More specifically, the embodiment of this invention includes the following three features.

(1) Unified Management of Dispersed Personal Information on the User Terminal

The user's personal information should essentially be managed by that user, and the user should also possess the right to control access to information requests from external terminals. However personal information is currently managed while stored in system databases established by the individual service providers. Therefore, controlling the personal information flexibly and in real-time in compliance with that user's preferences was impossible.

In view of these circumstances, the user terminal 101 manages the personal information 114 and the access control information 113. A typical connection for example is made to the entire personal information 114 containing information relating to user preferences such as purchase history and search results, in addition to basic personal information such as the name and address, and that information is stored in the user terminal 101 (or IC chip stored in the user terminal 101). The access control policy for the personal information is set in each item and is stored in the user terminal 101 (or internal IC chip).

The reason for storing the personal information within the IC chip is that the IC chip is a tamper-resistant device and offers a high degree of security as a storage location for personal information. A cellular telephone may generally be utilized as the user terminal.

(2) Access Control Processing by External Access Control Server

When the user himself is storing and managing personal information under his immediate control, the user must control what information to disclose in response to external requests. However under the current circumstances, the complex access control tasks that are involved place a heavy processing burden on the cellular telephone or IC card that typically serves as the user terminal.

Therefore, in the embodiment of the present invention, the external service terminal 121 requesting access to personal information, entrusts the external access control server 131 with access control processing that decides whether or not conditions recorded in the access control policy are satisfied. The user terminal 101 then receives the decision result and selectively discloses the personal information based on that decision result. Entrusting the processing to the external access control server 131 in this way, eliminates the necessity for the user terminal 101 to process complex decision results and their heavy processing load.

Connecting to the external access control server 131 creates the problem that network traffic increases. Generally however, external servers are accessed in order to void the certification document used in the business processing and mutual authentication between devices. Network access is therefore necessary to some extent but the traffic increase resulting from the method of this invention is small.

(3) Confidentiality of Access Control Policy and Attribute Information

When the access control server 131 processes the access control decision there is a problem as related previously that the external service terminal profile and the access control policy are disclosed to the access control server 131.

In the embodiment of this invention however, the user terminal 101 and external service terminal 121 mutually authenticate each other when the service starts and jointly share a session key. By then using that joint session key, the access control policy data and the attribute information of the external service terminal 121 needed for the decision are encoded (or encrypted) and sent to the access control server 131 so that the data is not revealed to access control server 131 and confidentiality is maintained. The access control server 131 then decides the policy by using the external service terminal profile data 123 and the access control policy data 113 that was received.

The access control server 131 compares the encoded access control policy 113 and the encoded external service terminal profile data 123, decides if the conditions recorded in the policy 113 are true or false, and returns the decision results to the user terminal 101. The content of the data utilized for the decision are encoded so that the access control server 131 does not know their content. The access control server 131 only decides whether both (113 and 123) are a match to allow making a decision on access control. The access control server 131 preferably supplies an electronic signature to certify that the decision results are genuine and then sends the decision results.

The user terminal 101 selects and discloses the personal information to the external service terminal 121 based on the decision results from the access control server 131. The external service terminal 121 provides the following service by utilizing the supplied data.

The user terminal 101 preferably encodes and sends the personal information using the joint session key. The external service terminal 121 in that case, decodes the personal information by using the joint session key.

The embodiment of this invention is described next while referring to the drawings.

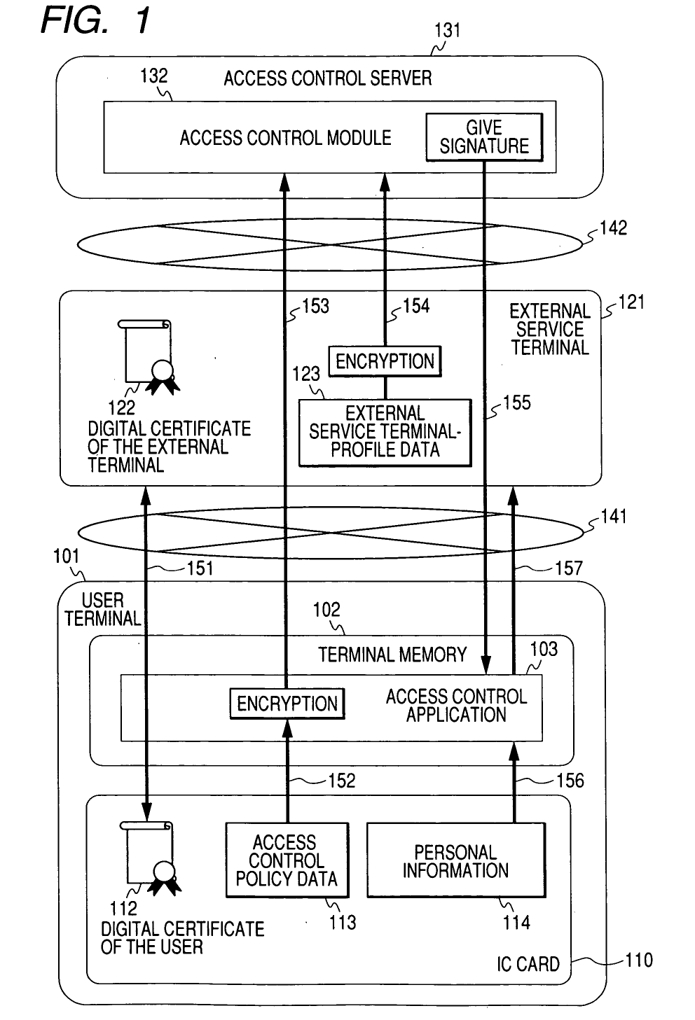

FIG. 1 is a block diagram showing the structure of the computer system of the embodiment of this invention.

The computer system of the embodiment of this invention includes a user terminal 101, an external service terminal 121, an access control server 131 and the networks 141, 142.

The user terminal 101 is a computer for accessing a service on the network. The external service terminal 121 is a computer for providing services to the user, and utilizes personal information to implement the service tasks. The access control server 131 is a server for deciding whether to allow the external service terminal 121 access to the personal information retained in the user terminal 101.

A network 141 connects the user terminal 101 and the external service terminal 121. The network 141 is a cellular telephone network or short-distance wireless network (such as Bluetooth and infrared rays, etc.).

A network 142 connects the access control server 131 and the external service terminal 121. The network 142 is a communication network such as the Internet or dedicated lines capable of transferring massive quantities of data

Unlike the user terminal 201 of the related art, the user terminal 101 easily conveys the users own preferences and therefore a cellular information terminal (cellular telephone or PDA etc.) constantly carried by the user is preferable.

The user terminal 101 includes a CPU (not shown in drawing) and a terminal memory 102. The terminal memory 102 stores an access control application program 103, and other application programs and scripts, etc.

The CPU executes the application programs and scripts stored in the terminal memory 102. The CPU in particular relays data by executing the access control application program 103.

The user terminal 101 includes an IC card interface (not shown in drawing), and the IC card 110 may be installed within the user terminal memory 101. The IC card interface transfers data between the user terminal 101 and the IC card 110.

The MOPASS card (http://www.mopass.info/), the UIM card (http://k-tai.impress.co.jp/cda/article/news_toppage/9143.h tml), FeliCa card (http://www.nttdocomo.co.jp/p_s/service/felica/) may for example be utilized as the IC card capable of being installed internally within a cellular telephone.

A digital certificate of the user 112, the access control policy data 113 and the personal information 114 are stored within the IC card 110. The digital certificate of the user 112 is the so-called electronic certification document. More specifically, this document is utilized as a public key certification to which a third party authentication institution has affixed an electronic signature. Conditions for accessing each item of the personal information, and the access types (read only, write, etc.) are recorded in the access control policy data 113.

In the following description, the IC card can be installed internally in the user terminal. However when the IC card 110 cannot be installed within the user terminal 101, then the same operation can be performed in the user terminal 101 by storing the memory contents of the IC card 110 into the terminal memory 102. If the memory contents of the IC card 110 are stored in the terminal memory 102, then a higher level of security can be provided since the data is stored in a tamper-resistant device.

The external service terminal 121 is a computer including a memory and a storage device. The CPU within the external service terminal 121 executes the programs stored in the memory and transfers data sent from the user terminal 101, to the access control server 131. The storage device within the external service terminal 121 stores the digital certificate of the external terminal 122 and the external service terminal-profile data 123.

The digital certificate of the external terminal 122 is the so-called electronic certification document and is utilized the same as the digital certificate of the user 112.

The data stored in the IC card 110 and the external service terminal 121 is stored in the memory or storage device as data or a data file and may also be stored within a database.

The access control server 131 is a computer including a CPU and memory. The CPU within the access control server 131 contains an access control (processor) unit 132 for executing access control programs stored in the memory.

The user terminal 101, the external service terminal 121 and the access control server 131 possess processors for sending and receiving the respective data, however these processors are omitted in the drawings.

The information access control sequence of this embodiment is described next.

The user terminal 101 and the external service terminal 121 first of all exchange the digital certificate of the user 112 and a digital certificate of the external service terminal 122 and mutually authenticate each other (151). The external service terminal 121 confirms by means of the digital certificate of the user 112 that the user terminal 101 is genuine. The user terminal 101 confirms by means of the digital certificate of the external terminal 122 that the external service terminal is genuine.

Temporary session keys are exchanged (or mutually generated) if the authentication results are authentic, and joint keys for the user terminal 101 and the external service terminal 121 are set-up. DES (Data Encryption Standard) encoding keys may be utilized as these session keys.

The user terminal 101 encodes (or encrypts) the access control policy data 113 stored in the IC card 110 by using the session keys jointly set with the external service terminal 121. The user terminal 101 sends this encoded data to the access control server 131 and requests a policy decision (152, 153).

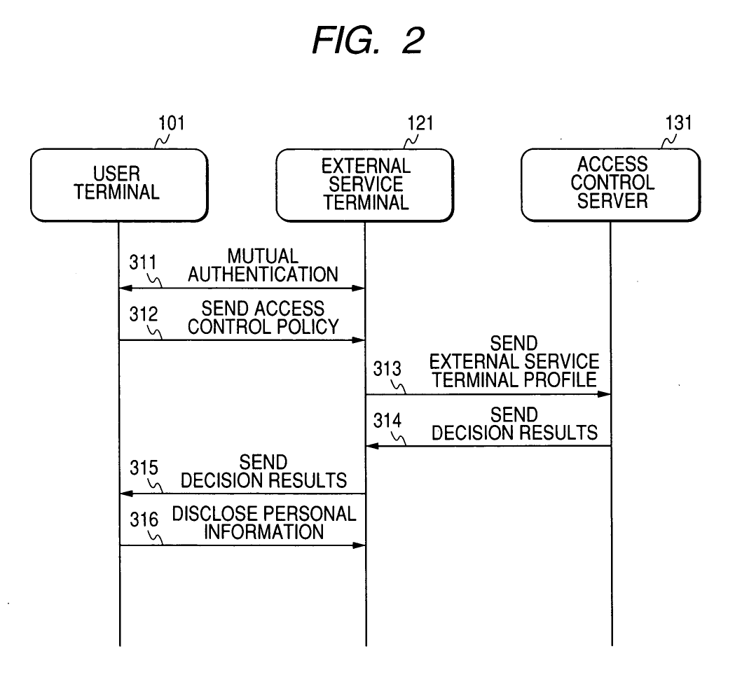

The access control policy data 113 may be sent via the external service terminal 121 as described in FIG. 2 or may be sent directly to the access control server 131.

The external service terminal 121 encodes the external service terminal-profile data 123 in the same way (as data 113) by using the session key exchanged with the user terminal 101. The external service terminal 121 then sends this encrypted data to the access control server 131 and requests a policy decision (154).

When the access control server 131 receives the access control policy data 113 and the external service terminal-profile data 123, the access control module 132 identifies the policy and sends the decision result to the user terminal 101 (155). The access control server 131 attaches an electronic signature to the decision result in order to guarantee their authenticity, and sends those decision results.

The user terminal 101 accepts the decision results from the access control server 131 and confirms the decision results are genuine by means of the electronic signature. The user terminal 101 then discloses only the personal information 114 specified in the decision result to the external service terminal 121 (156, 157).

The external service terminal 121 then proceeds to provide the business service by utilizing the personal information disclosed from the user terminal 101.

The information access control processing of the present embodiment is described next in specific detail.

FIG. 2 is a sequence chart showing the information access control processing of the embodiment of this invention.

The information access control processing of the embodiment of this invention is broadly grouped into three phases made up of the mutual authentication phase, the policy decision phase and the individual information disclosure phase.

The user terminal 101 and the external service terminal 121 first of all exchange a digital certificate, mutually authenticate each other, and then establish a session (step 311).

The user terminal 101 and the external service terminal 121 jointly possess a session key based on the authentication results between the external service terminal 121 and user terminal 101. The user terminal 101 sends the access control policy data 113 encoded using the session key, to the external service terminal 121 (step 312).

The external service terminal 121 encodes the external service terminal-profile data 123 by using the session key. The external service terminal 121 sends the encoded external service terminal-profile data 123 along with the access control policy data 113, to the access control server 113 (step 313).

The access control policy data 113 may be sent directly from the user terminal 101 to the access control server 131 without transiting the external service terminal 121. The data may in other words be sent by any method as long as the access control server 131 can be provided with access control policy data and external service terminal profile data.

When sending the access control policy data by way of the external service terminal 121, the connection between the external service terminal 121 and the access control server 131 is probably made via a network possessing a large data transmission capacity such as a dedicated cable line (compared to a cellular telephone network) so that the time for sending and receiving time is usually short. The access control policy data and the external service terminal profile data moreover are matched within the external service terminal 121 and sent to the access control server 131, so that the task of the access control server 131 matching both data is eliminated. However, the contents of the access control policy are in that case disclosed to the external service terminal so that the user or the operator of the user terminal who wished to avoid this (disclosure) should preferably send the data directly to the access control server 131 without transiting the external service terminal 121.

The access control server 131 decides the user policy based on the access control policy data 113 and external service terminal provider data 123 that were received, and sends the decision results to the external service terminal 121 (step 314).

The external service terminal 121 sends the decision results to the user terminal 101 and requests the disclosure of personal information (step 315).

The user terminal 101 discloses the personal information specified in the decision results after confirming that the received decision results are genuine (step 316).

The external service terminal 121 utilizes the personal information disclosed from the user terminal 101 to execute the following processing to provide services.

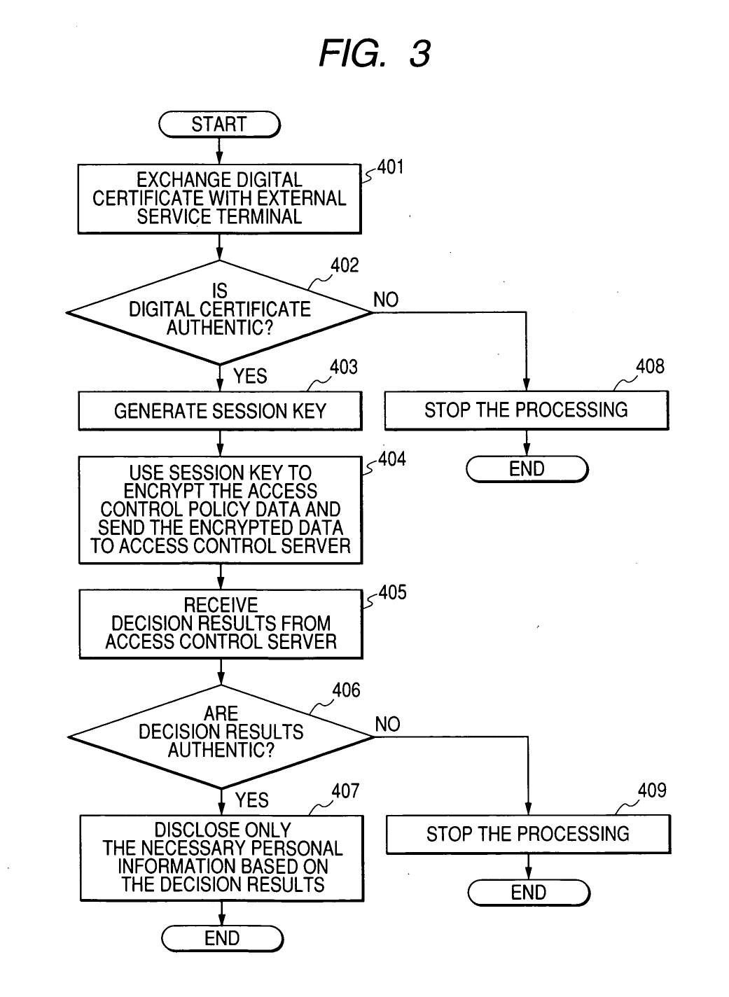

FIG. 3 is a flowchart of the processing by the user terminal 101 in the embodiment of this invention.

The user terminal 101 first of all replaces its data with a digital certificate from the external service terminal 121 (step 401).

The user terminal 101 next verifies whether the digital certificate sent from the external service terminal 121 is authentic (step 402). If the authentication results are not valid or the digital certificate is false, then the user terminal 101 decides that the external service terminal 121 is not genuine and stops the processing (step 408). In this case, a display such as “Authentication Failed” appears on the user terminal screen. On the other hand, if the digital certificate is authentic, then the external service terminal 121 is confirmed as genuine so the session key generated by the external service terminal 121 is jointly used (between 101 and 121) (step 403). The joint session key may be generated using rules that are common to both the user terminal 101 and the external service terminal 121.

The user terminal 101 then utilizes session key jointly shared with the external service terminal 121 to encode the access control policy data and that data is then sent to the access control server 131 (step 404). The access control policy data 113 is sent to the external service terminal 121 address when sending it (113) via the external service terminal 121.

The user terminal 101 then accepts those policy decision results (step 405) from the access control server 131, uses the electronic signature attached to the policy decision results to decide whether the access control server 131 is genuine, and confirms that the decision results are genuine (step 406).

If the result is that the electronic signature is not correct, then the policy decision results are decided to be incorrect and the processing is stopped (step 409). A display “Authentication Failed” may here be shown on the user terminal screen. On the other hand, if the electronic signature is correct, then the policy decision results are decided to be genuine, and just the required personal information is disclosed to the external service terminal based on the decision results (step 407). Sending the personal information after first encoding it utilizing the session key is preferably from the viewpoint of keeping the personal information confidential. Moreover, the processing of step 407 is executed, if the decision results are valid even if there is no personal information to disclose.

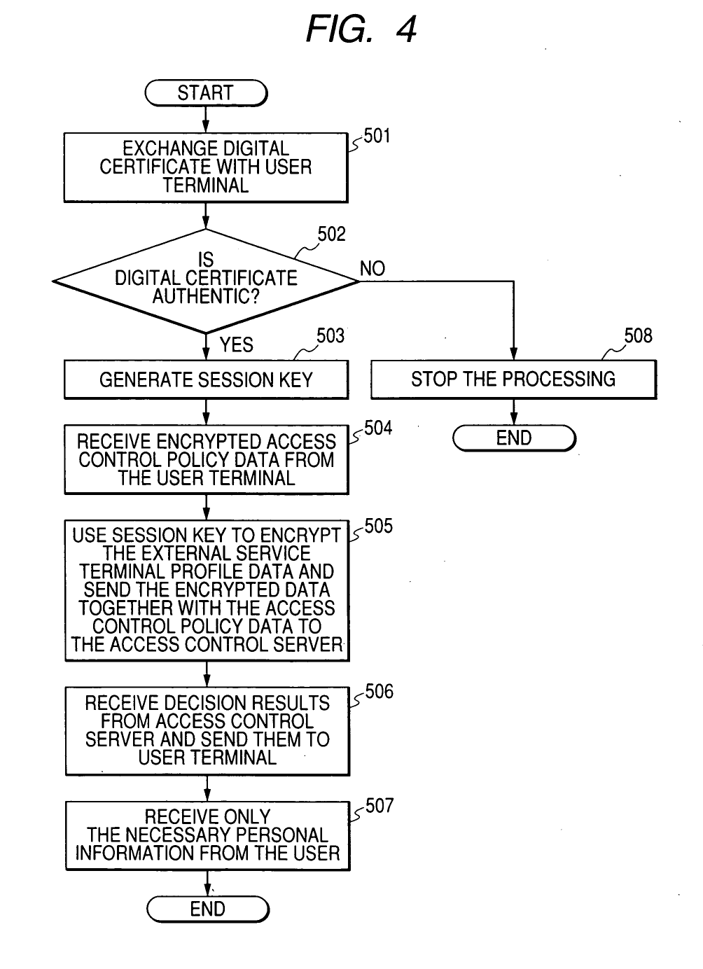

FIG. 4 is a flowchart of the processing by the external service terminal 121 in the embodiment of this invention.

The external service terminal 121 first of all exchanges a digital certificate with the user terminal 101 (step 501).

The external service terminal 121 next verifies whether the digital certificate sent from the user terminal 101 is genuine (step 502). If the authentication results are not valid or the digital certificate is false, then the external service terminal 121 decides that the user terminal 101 is not genuine and stops the processing (step 508). In this case, a display such as “Authentication Failed” appears on the external service terminal screen. On the other hand, if the digital certificate is authentic, then the user terminal 101 is confirmed as genuine so a session key is generated and sent to the user terminal 101 based on rules jointly shared by the user terminal 101 and the external service terminal 121. A session key is in this way jointly utilized by the external service terminal 121 and the user terminal 101 (step 503).

The external service terminal 121 next accepts the encoded access control policy data from the user terminal 101 (step 504), encodes the external service terminal profile data by utilizing the session key jointly shared with the user terminal 101. The external service terminal 121 then sends this (profile) data along with the access control policy data received in step 504 to the access control server 131 (step 505).

After receiving the policy decision results from the access control server 131, the external service terminal 121 then sends the received policy decision results to the user terminal 101 (step 506).

The required personal information is later accepted from the user terminal 101 (step 507). If the received personal information is encoded then that personal information is decoded using the session key. The following service is then provided using the personal information disclosed from the user terminal 101.

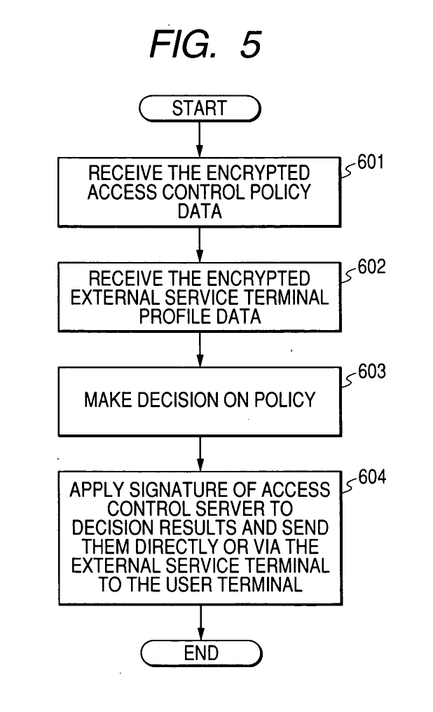

FIG. 5 is a flowchart showing the processing by the access control server 131 of the embodiment of this invention.

The access control server 131 accepts the encoded access control policy data from the user terminal 101 via the external service terminal 121 (or directly) (step 601). The access control server 131 also accepts the encoded external service terminal profile data from the external service terminal 121 (step 602).

The access control server 131 then makes a decision on the policy based on data that was received (step 603). The access control server 131 then attaches an electronic signature to the decision results and sends them via the external service terminal 121 to the user terminal 101 (step 604). The access control server 131 can then send the decision results to the user terminal 101 via the external service terminal 121.

The policy decision process is next described in detail.

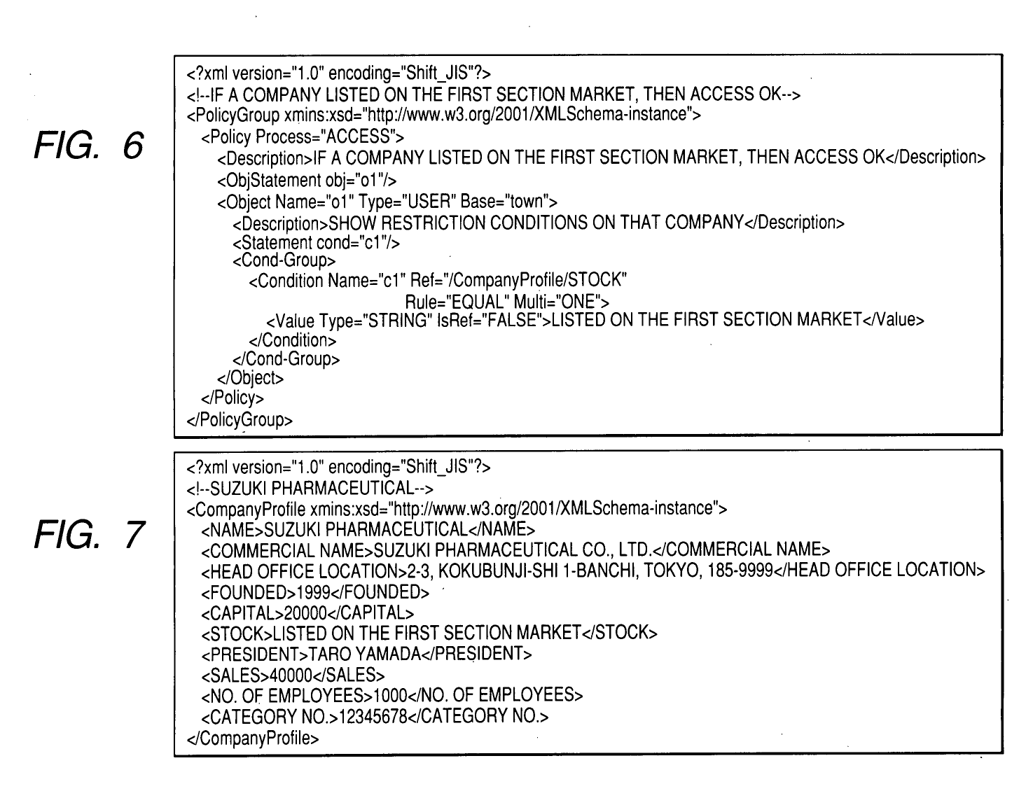

FIG. 6 is a figure showing an example of the access control policy data 113 of the embodiment of this invention.

This policy 113 is an access control policy set in the first item of the personal information, and displays the condition, “If a company listed on the first section market then access OK” as the profile provided by the external service provider. In this example, the <Ref> attribute within the <Condition> tag specifies the reference path for the profile data. The decision condition is recorded in the <Rule> attribute, and the data for comparison is listed in the <Value> tag. If the value in the reference specified for the profile data is “listed on the first section market” then the decision is that the condition is true.

FIG. 7 is an example of the external service terminal profile data 123 corresponding to the access control policy data shown in FIG. 6.

The information, “Listed on the first section market” is stored under the <Stock> tag within the <CompanyProfile> tag set in the <Ref> attribute of the access control policy data, and therefore these decision results are true (valid).

The policies shown in FIG. 6 and FIG. 7 are the simplest possible examples. Complex conditions can be expressed in large amounts by using combinations of these tags.

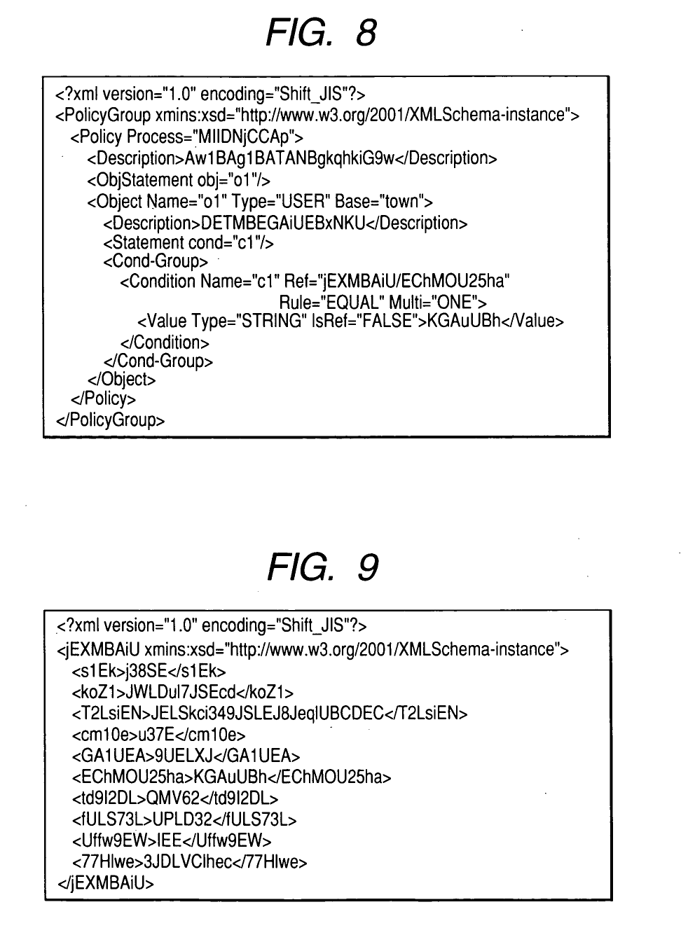

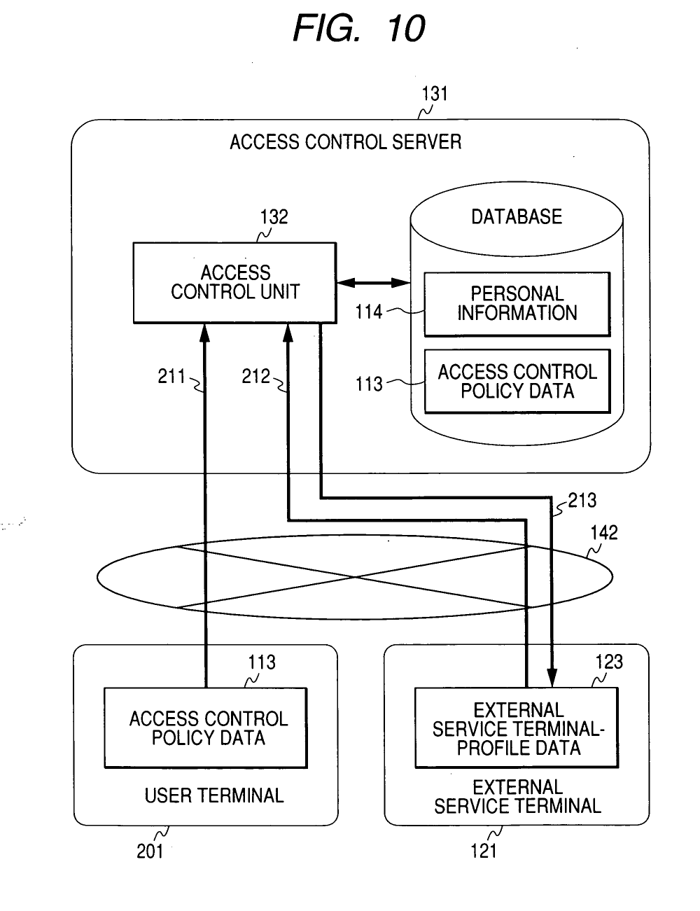

The access control server 131 encodes the access control policy data and the external service terminal profile data 123 at the point in time that these datum are received, and the tag name and value are encoded to keep the contents confidential. The encoded access control policy data is shown in FIG. 8. The encoded external service terminal profile data is shown in FIG. 9.

In the encoded access control policy data, the “KGAuUBh” is stored in the <EChMOU25ha> tag within the <jEXMBAiU> tag specified under the <Ref> attribute. The tag is identified in an encoded state in this way, and the parameters compared so that the access control server 131 does not know the contents of the access control policy data 113 and the external service profile data 123.

The present embodiment utilizes a DES encoding key however the method for generating the key and the algorithm for encoding and decoding is not limited to DES (Data Encryption Standard).

The user's personal information can therefore be managed on the user terminal 101 in the embodiment of this invention as already described so that personal information can be entirely managed that individual, and the privacy of that information can be protected.

The user defines conditions for accessing the applicable information as access control policy data and stores these in the user terminal 101 the same as the personal information. The latest policy can in this way be constantly applied and the user's preferences implemented in real-time.

Also, the access control decision process involving a large processing load is entrusted to the access control server 131 so that the load on the user terminal 101 and the external service terminal 121 is lightened. The data that the user terminal 101 and the external service terminal 121 send to the access control server 131 is encoded so that the confidentiality of the data is maintained.

The invention as described above can be applied to the following services.

(1) Book/Magazine Purchasing and Rental Services

The user can store book and magazine data found from searching the Internet or mail magazines as personal information in the user terminal. Purchases histories such as for net mail-order can also be stored in the same way in the user terminal as personal information.

After visiting in book stores in town or kiosks at the train station, or the library, the user can disclose information on preferences among these books and magazines so that introductions to the latest recommended books and information on locations of desired magazines can be provided to the user.

In this case, all information can be disclosed if a public institution such as a library, however to avoid disclosing excessive personal information, the user can set detailed access conditions for disclosing only the latest search data on city bookstores and train station kiosks.

Unlike personal information stored in a service provider database, the personal information (of this invention) is stored in the user terminal so that there is no danger of the information being misused by the service provider or the information being divulged elsewhere. Moreover, even if the user terminal is lost, the personal information is stored within a tamper-resistant device (such as an IC chip) so that the danger of the personal information being read by a third party can be avoided.

(2) Context-aware Services

Information on preferences for a pleasant individual space (such as air conditioning temperature settings and light intensity or coloring, type of BGM, seating settings) can be set in the user terminal as personal information. When the user visits locations such as a hotel, conference location, or traffic facility for the first time, and after completing the authentication process, the user can disclose information on these locations to receive services matching individual preferences such as room temperature, BGM, and seating angle, etc.

This service can also be applied to route guidance or departure time notices at train stations and within airports by combining with electronic ticket reservation (services) at traffic facilities.

(3) Linking with Other Multiple Services

Besides the above services in (1) and (2), links can be made to multiple services via the personal information stored in the user terminal. For example the counter at a cosmetics manufacturer can be linked to a website offering word-of-mouth information on cosmetics. The user can in this way link at any time to inventory information (i.e. stock availability) of a product that matches the user's skin characteristics and is also highly rated by word-of-mouth information, and can then make a purchase.

What is claimed is:

1. An access control server connected to a user terminal owned by the user, and to an external service terminal for providing a service to the user terminal, comprising:
an access control unit for controlling access from external service terminals to personal information retained in the user terminal,
wherein the access control unit accepts the external service terminal attribute information and the access control policy for setting the access rights to the personal information held in the user terminal,
decides whether to grant access rights based on the accepted external service terminal attribute information and the accepted access control policy, and
sends the decision results to the user terminal.

2. An access control server according to claim 1, wherein the access control unit accepts an access control policy via the external service terminal.

3. An access control server according to claim 1, wherein the access control unit accepts the access control policy directly from the user terminal of the access control server.

4. An access control server according to claim 1, wherein the access control unit attaches an electronic signature to the decision results, and sends the decision results to the user terminal.

5. A user terminal connected to an access control server for controlling access to personal information from an external service terminal, comprising:
an access control unit for controlling the sending and receiving of information; and
a storage device for storing information,
wherein:
the storage device stores the access control policy for setting access rights to personal information, and the user's personal information, and
the access control unit sends the access control policy stored in the storage device, to the access control server,
receives the decision results from the access control server,
selects personal information that can be disclosed externally based on the decision results, and
sends the selected personal information.

6. A user terminal according to claim 5, wherein:
the storage device stores user terminal authentication data for certifying that a terminal is genuine, and
the access control unit:
exchanges the user terminal authentication data with the external service terminal, performs mutual authentication,
when the mutual authentication is successful, encodes the access control policy by using the session key, and
sends the encoded access control policy to the access control server.

7. A user terminal according to claim 6, wherein the storage device is a recording medium capable of being attached or detached from the user terminal, and stores information for encoding the access control policy and the program for mutual authentication.

8. A user terminal according to claim 5, wherein the user terminal is connected to an external service terminal for providing a service, and the access control unit send the access control policy via the external service terminal.

9. A user terminal according to claim 5, wherein the user terminal is connected to an external service terminal for providing a service, and the access control unit directly sends the access control policy to the external service terminal.

10. An access control method for a computer system including a user terminal holding information possessed by the user, and an external service terminal for supplying a service to the user terminal, and an access control server for controlling access from an external service terminal to user information retained in a user terminal, wherein
the user terminal and the external service terminal exchange authentication data and perform mutual authentication,
when the mutual authentication was successful, the user terminal utilizes the session key that was set, to encode the access control policy for setting access rights to personal information held in the user terminal, and send the encoded access control policy to the access control server,
when the mutual authentication was successful, the external service terminal utilizes the session key that was set, to encode the external service terminal attribute information for indicating the attributes of the terminal, and sends the encoded external service terminal attribute information to the access control server,
the access control server accepts the external service terminal attribute information and the access control policy, analyzes the accepted access control policy, decides the access rights of the external service terminal after referring to the external service terminal attribute information that was accepted, and sends the decision results to the user terminal,
the user terminal accepts the decision results from the access control server, and selects personal information that can be disclosed externally, based on the accepted decision results, and
the external service terminal accepts the personal information from the user terminal.
